(19) United States
(12) Patent Application Publication
(10) Pub. No.: US 2019/0155919 A1
(43) Pub. Date: May 23, 2019

(54) PERFORMING DEDUPLICATION ON CLOUD-RESIDENT ENCRYPTED DATA

(71) Applicant: INTERNATIONAL BUSINESS MACHINES CORPORATION, ARMONK, NY (US)

(72) Inventors: Akshar Kaul, Bangalore (IN); Sameep Mehta, New Delhi (IN); Krishnasuri Narayanam, Bangalore (IN); Ramasuri Narayanam, ANDHRA PRADESH (IN)

(21) Appl. No.: 15/817,409

(22) Filed: Nov. 20, 2017

(51) Int. Cl. G06F 17/30; H04L 29/06; H04L 9/06

(52) U.S. Cl. CPC G06F 17/30156; G06F 17/30112; G06F 17/30106; H04L 9/0618; H04L 63/0435; H04L 63/0442; H04L 63/061

(57) ABSTRACT

A processor-implemented method may generate one or more deduplication maps based on analyzing the data and one or more encryption keys. The method may perform deduplication of the data based on the one or more deduplication maps, where deduplication may convert the data into plain data blocks and deduplicated data blocks. The method may encrypt the plain data blocks and the deduplication data blocks and transfer the one or more deduplication maps, the encrypted plain data blocks, and the encrypted deduplicated data blocks to a server.

### BACKGROUND

The present invention relates, generally, to the field of computing, and more particularly to deduplication of encrypted data stored on a cloud.

Data deduplication is a specialized data compression technique for eliminating duplicate copies of repeating data. For example, a typical email system might contain 100 instances of the same 1 MB file attachment. Each time the email platform is backed up, all 100 instances of the attachment are saved, requiring 100 MB storage space. With data deduplication, only one instance of the attachment is actually stored; the subsequent instances are referenced back to the saved copy for deduplication ratio of roughly 100 to 1.

Cloud computing is a form of Internet-based computing that provides shared computer processing resources and data to computers and other devices on demand. Cloud computing is a model for enabling ubiquitous, on-demand access to a shared pool of configurable computing resources (e.g., computer networks, servers, storage, applications and services), which may be rapidly provisioned and released with minimal management effort.

A hybrid cloud environment is, typically, a cloud computing environment that uses a combination of on-premises, private cloud and third-party, public cloud services by synthesizing between the two platforms. The synthesizing is defined as allowing workloads to move between private and public clouds as computing needs and costs change. The hybrid cloud solutions give businesses greater flexibility and more data deployment options.

### SUMMARY

According to one embodiment, a method, computer system, and computer program product for processor-implemented method for data deduplication on cloud-resident encrypted data is provided. The present invention may include a processor-implemented method that may generate one or more deduplication maps based on analyzing the data and one or more encryption keys. The method may perform deduplication of the data based on the one or more deduplication maps, where deduplication may convert the data into plain data blocks and deduplicated data blocks. The method may encrypt the plain data blocks and the deduplication data blocks and transfer the one or more deduplication maps, the encrypted plain data blocks, and the encrypted deduplicated data blocks to a server.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2A is an operational flowchart illustrating a data ingestion process according to at least one embodiment;

FIG. 2B is an operational flowchart illustrating deduplication and encryption processes during data ingestion according to at least one embodiment;

FIG. 3A is an operational flowchart illustrating a query response process according to at least one embodiment;

FIG. 3B is an operational flowchart illustrating deduplication and decryption process during query response according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to cloud computing data deduplication. The following described exemplary embodiments provide a system, method, and program product to, among other things, performing deduplication on cloud resident encrypted data. Therefore, the present embodiment has the capacity to improve the technical fields of data transfer and data security by locally deduplicating and encrypting the data before transferring it over the internet to the server.

As previously described, cloud computing is a form of Internet-based computing that provides shared computer processing resources and data to computers and other devices on demand. Cloud computing is a model for enabling ubiquitous, on-demand access to a shared pool of configurable computing resources (e.g., computer networks, servers, storage, applications and services), which may be rapidly provisioned and released with minimal management effort.

Typically, data stored on cloud computing devices, such as cloud servers, may be encrypted in order to protect the data from unauthorized access, especially on hybrid cloud platforms. Migrating encrypted data to cloud requires the client computing device to send large amount of data to the cloud server, leading to huge network traffic. Additionally encrypting the whole data requires huge computation resources from the client. As such, it may be advantageous to, among other things, implement a system that first performs data deduplication and then encrypts the deduplicated data on the client computing device and, thereafter, forward the deduplicated encrypted data to the server.

According to one embodiment, a client computing device may perform a data deduplication and divide the data into plain data blocks, deduplication data blocks and a deduplication map that stores the location of the plain data blocks and the deduplicated data blocks in the original data. The client computing device may then encrypt the plain data blocks and the deduplicated data blocks and send the encrypted deduplicated data (consisting of encrypted plain data blocks, encrypted deduplicated data blocks and deduplication map) to a server. When a query is received, the client computing device may receive the deduplication map, encrypted plain data blocks and encrypted deduplicated data blocks from the cloud server, and, after decryption and reconstruction, perform a search using the query. In another embodiment, when a query is received, the client computing device may cause the server to determine the corresponding encrypted plain data blocks and the encrypted deduplicated data blocks that are relevant to the query based on the deduplication map, and send the relevant data for decryption on the client computing device.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to perform data encryption and deduplication on a client computing device and then transfer the encrypted and deduplicated data for storage on a cloud server.

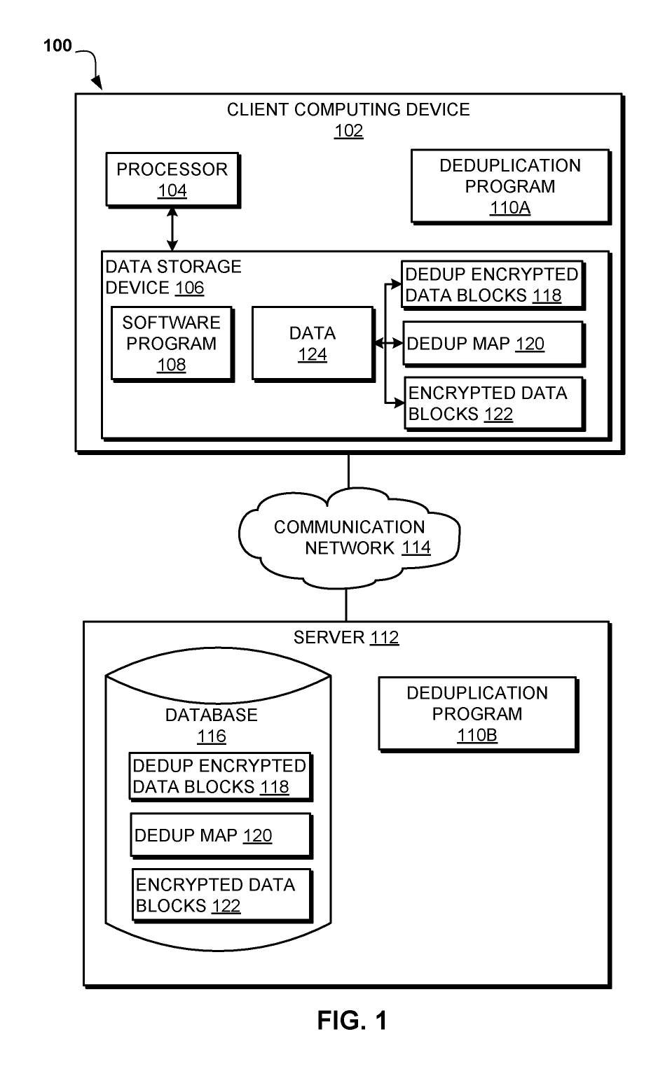

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

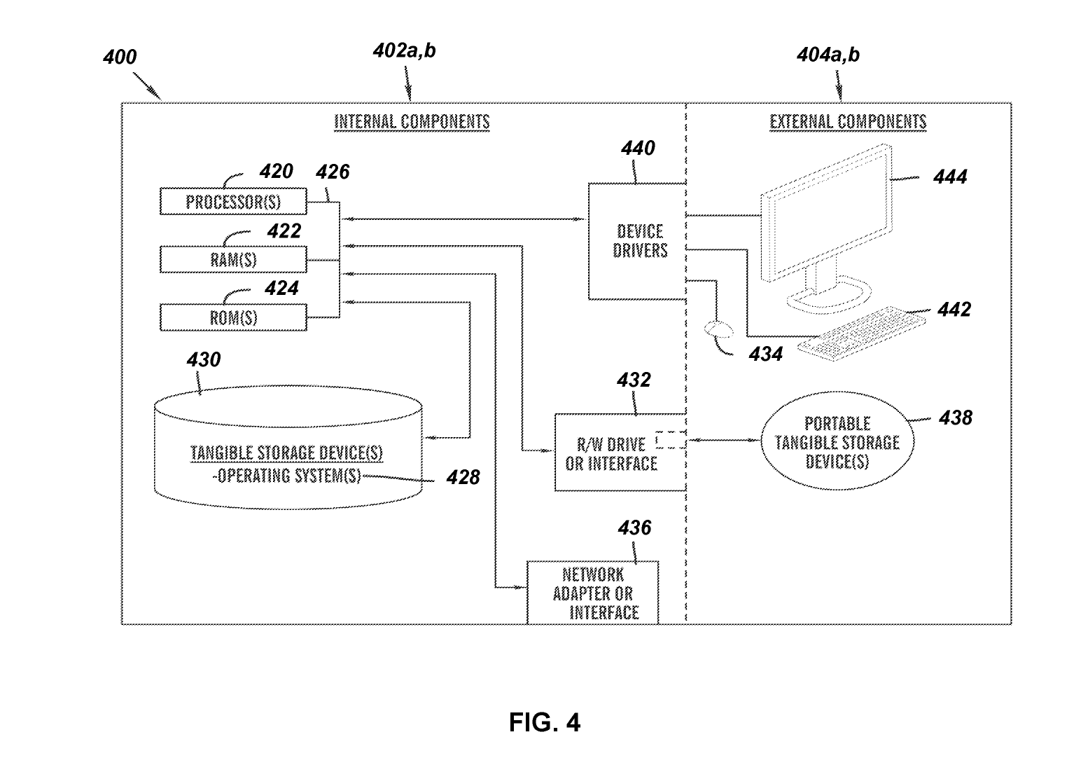

Client computing device 102 may include a processor 104 and a data storage device 106 that is enabled to host and run a software program 108 and a deduplication program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

Data storage device 106 may be enabled to host data 124, deduplicated encrypted data blocks 118, deduplication map 120, and encrypted data blocks 122. Data 124 may be any digital information that a user of client computing device 102 intends to store on server 112. Deduplicated encrypted data blocks 118 may be deduplicated (recurrent) data blocks from data 124 encrypted by deduplication program 110A. Deduplication map 120 may be metadata in the form of an array, table, matrix or other digital data storage format that stores the location of the deduplicated data blocks of data 124 before data 124 was deduplicated and encrypted.

The server computer 112 may be a laptop computer, netbook computer, personal computer (PC), a desktop computer, or any programmable electronic device or any network of programmable electronic devices capable of hosting and running a deduplication program 110B and a database 116 and communicating with the client computing device 102 via the communication network 114, in accordance with embodiments of the invention. As will be discussed with reference to FIG. 4 the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

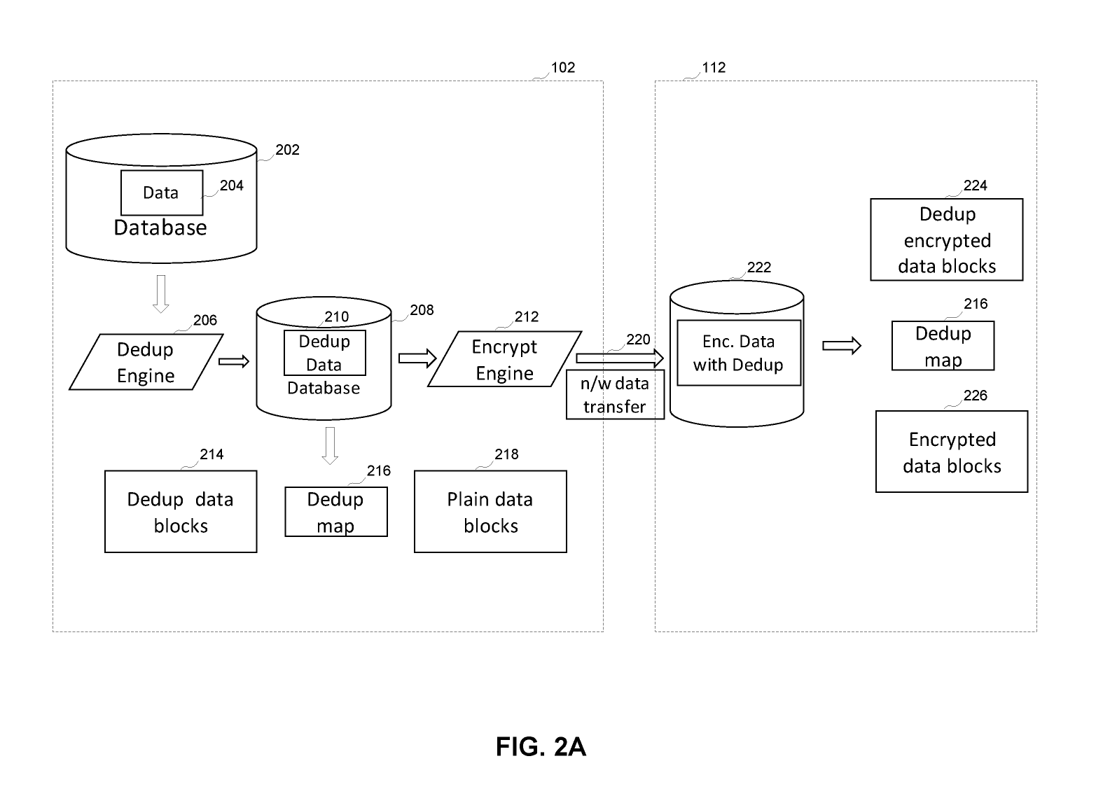

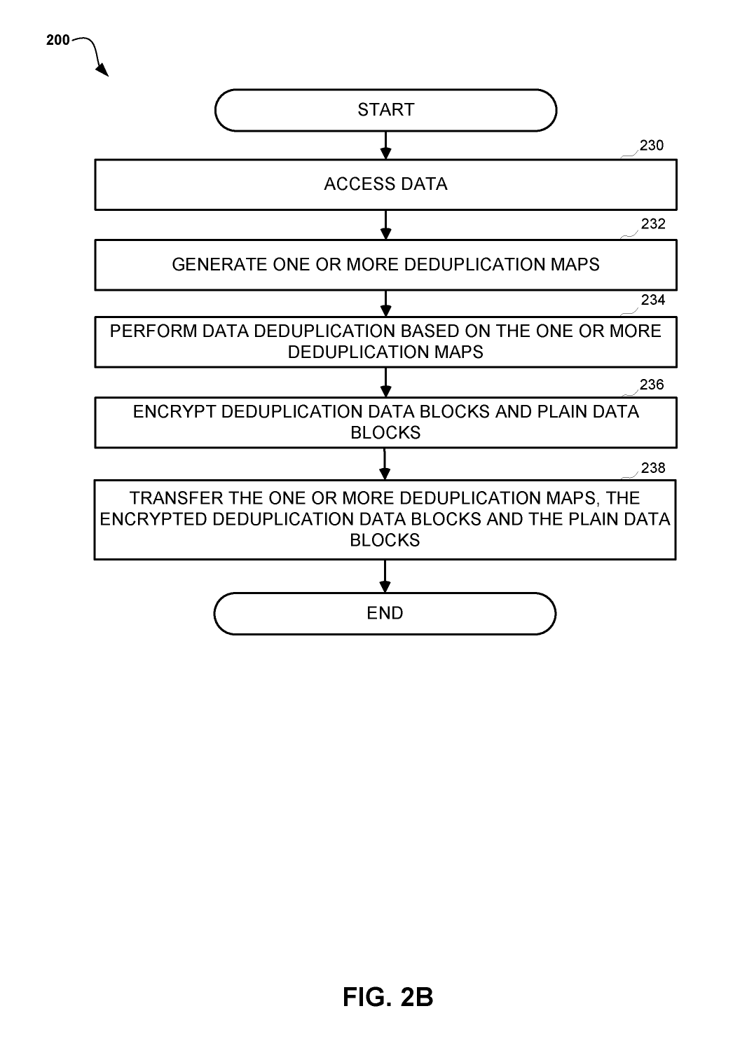

According to the present embodiment, the deduplication program 110A, 110B may be a program capable of receiving plain data blocks for deduplication on a client computing device 102 and converting the data into deduplication map, deduplication data, and remaining plain data blocks on the client computing device 102. Then, deduplication program 110A, 110B may encrypt, or cause the client computing device 102 to encrypt, the deduplicated data and the plain data using an encryption algorithm, such as deterministic encryption and transfer the encrypted data with unencrypted deduplication map to the server. The deduplication and encryption methods are explained in further detail below with respect to FIGS. 2A-2B.

Referring now to FIG. 2A, an operational flowchart illustrating a data ingestion process performed by deduplication program 110A, 110B is depicted. According to at least one embodiment, deduplication program 110A, 110B may perform the following operations on client computing device 102: (i) access data 204 that is stored in database 202; (ii) using deduplication engine, convert data 204 into deduplicated data 210, where deduplicated data 210 includes deduplication data blocks 214, deduplication map 216, and plain data blocks 218; (iii) using encryption engine 212, encrypt the deduplicated data blocks 214 and plain data blocks 218; (iv) transfer encrypted data and deduplication map 216 to server 112 by network data transfer 220; and (v) store the encrypted data with deduplication map in database 222, where the encrypted data includes deduplicated encrypted data blocks 224, deduplication map 216 and encrypted data blocks 226.

Referring now to FIG. 2B, an operational flowchart illustrating a deduplication and encryption during data ingestion process 200 is depicted according to at least one embodiment. At 230, the deduplication program 110A, 110B accesses data. The deduplication program 110A, 110B may access data 204 stored on data storage device 118. For example, deduplication program may access data 204 from database 202 that may be located on data storage device 106 of the client computing device 102.

Next, at 232, deduplication program 110A, 110B may generate one or more deduplication maps. According to at least one embodiment, deduplication program 110A, 110B may analyze the data and generate one or more deduplication maps based on the encryption requirements. For example, if data 204 is a table where each column is encrypted using a different key then deduplication program 110A, 110B may generate separate deduplication map for each key. In another embodiment, when data 204 includes different value formats such as strings and integers deduplication program 110A, 110B may generate one deduplication map for strings and additional one for integers.

Next, at 234, deduplication program 110A, 110B may perform data deduplication based on the one or more deduplication maps. According to at least one embodiment, deduplication program 110A, 110B may analyze the data and deduplicate it by moving repeating blocks to deduplicated data blocks 214 and updating the corresponding to the data block deduplication map 216, while not repeating data blocks are moved to plain data blocks 218. Deduplication program 110A, 110B may perform data deduplication to an extent determined by a user in a data deduplication ratio. A data deduplication ratio may be the number of bytes input to a data deduplication process divided by the number of bytes output. For example, if 100 GB of data consumes 10 GB of storage capacity after deduplication, the deduplication ratio is 10:1.

Next, at 236, deduplication program 110A, 110B may encrypt the deduplication data blocks and plain data blocks. According to at least one embodiment, if the block size of the encryption scheme being used is same as the block size of the data being deduplicated, the deduplication program 110A, 110B may call the encryption algorithm to encrypt each block of data independently. In another embodiment, if the block size of the encryption scheme being used is less than the block size of the data being deduplicated, the deduplication program 110A, 110B may split the data into chunks of size equal to the block size of the encryption scheme and encrypt these chunks using an appropriate mode of encryption as specified by the encryption scheme being used. For example, if the deduplication block size is double the size of the encryption block, then the deduplication block is divided into two chunks and these chunks are then encrypted using an appropriate mode of encryption as specified by the encryption scheme being used. In further embodiment, if the block size of the encryption scheme being used is more than the block size of the data being deduplicated, the deduplication program 110A, 110B may pad the data using some padding scheme specified by the encryption scheme and then perform an encryption over this padded data.

The encryption scheme being used by the deduplication program 110A, 110B to encrypt the data may be either deterministic encryption or randomized encryption. In addition, the encryption scheme being used to encrypt the data may be either a symmetric key encryption scheme or an asymmetric key encryption scheme.

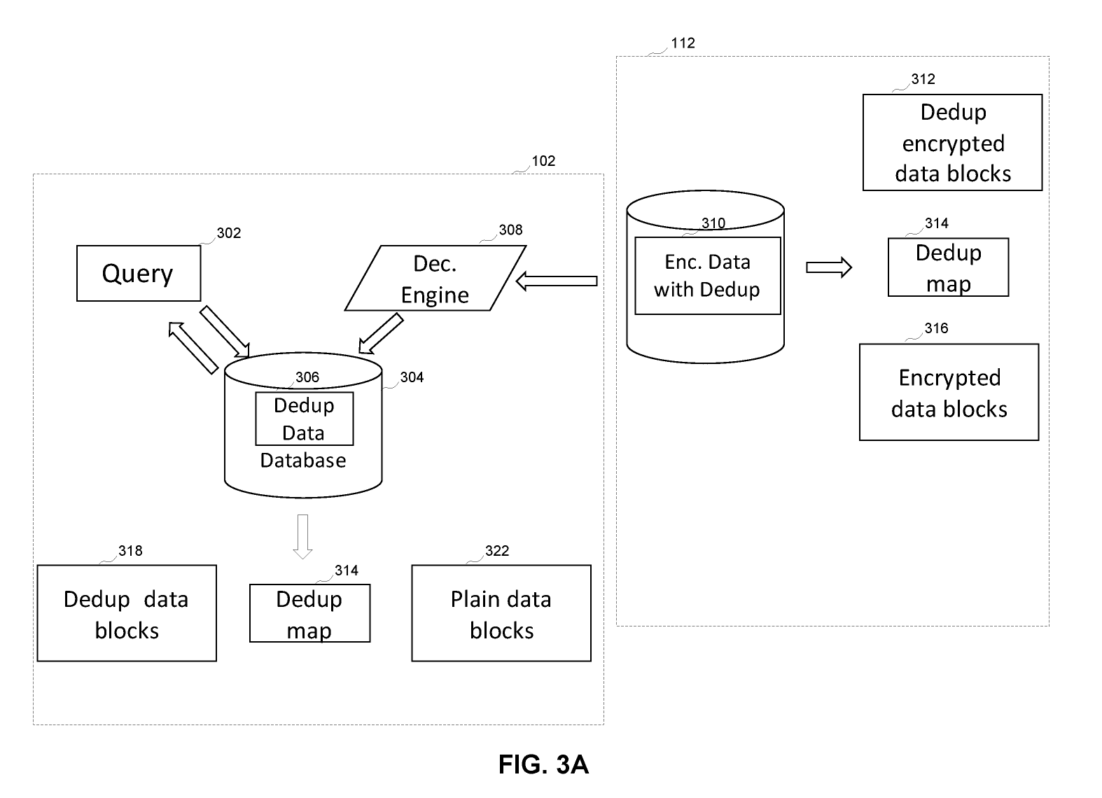

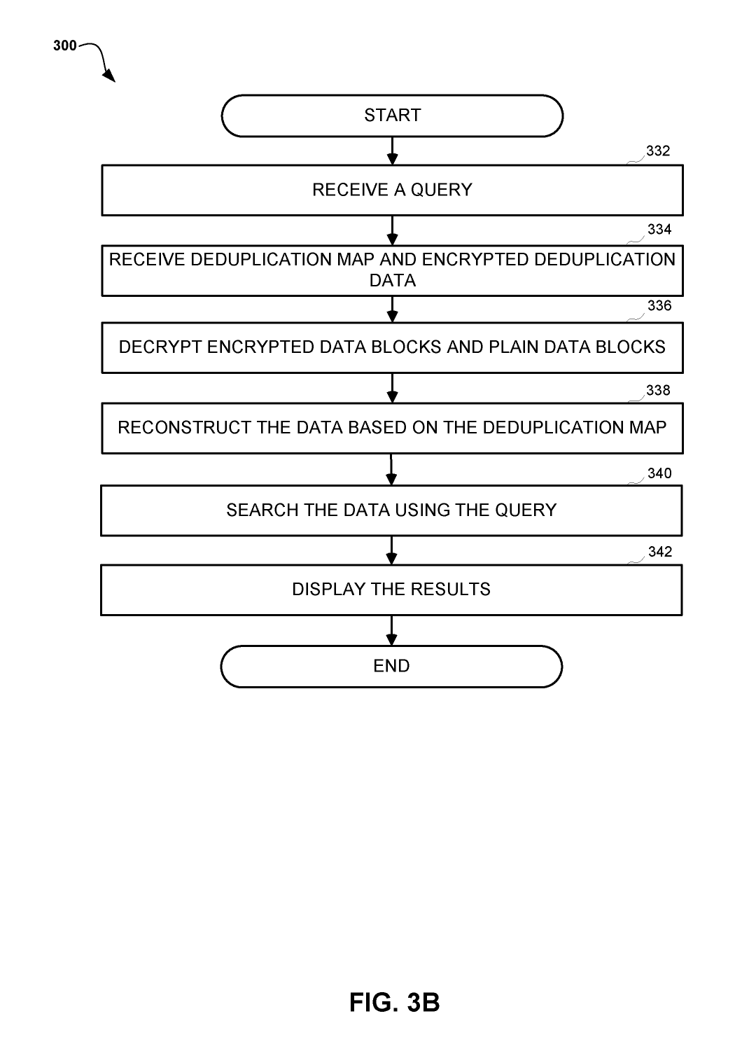

Next, at 238, deduplication program 110A, 110B may transfer the one or more deduplication maps, the encrypted deduplication data and the plain data blocks. According to at least one embodiment deduplication program 110A, 110B transfers the deduplicated encrypted data blocks 224, the deduplication maps, such as deduplication map 216, and the encrypted plain data blocks, such as encrypted data blocks 226, for storage on server 112. The deduplication and encryption methods during query response are explained in further detail below with respect to FIGS. 3A-3B.

Referring now to FIG. 3A, an operational flowchart illustrating a deduplication process during query response according to at least one embodiment by deduplication program 110A, 110B is depicted. According to at least one embodiment, deduplication program 110A, 110B may perform the following operations on client computing device 102: (i) receive query 302 from a user; (ii) receive encrypted data with deduplication 310 from server 112; (iii) using decryption engine 308 decrypt deduplicated encrypted data blocks 312 and encrypted plain data blocks 316 on database 304; (iv) using deduplication map 314 convert the deduplication data blocks 318 and plain data blocks 322 into undeduplicated data 306; (v) search the undeduplicated data 306 using query 302; and (vi) display the results.

Referring now to FIG. 3B, an operational flowchart illustrating a deduplication and decryption process 300 during a query response according to at least one embodiment is depicted. At 332, deduplication program 110A may receive a query. According to at least one embodiment, the query may be entered by a user of the client computing device 112 and forwarded to server 112, such as query 302, that is in a format compatible for performing a search in the deduplicated data 304. In another embodiment, after receiving the query, deduplication program 110A may forward an instruction to server 112 indicating that the query was received. In further embodiment, deduplication program 110A may convert the query to run over encrypted deduplicated data, using an encryption engine, a deduplication map or both and send it to server 112.

Next, at 334, the deduplication program 110A receives deduplication map and encrypted deduplication data. The deduplication program 110A may receive encrypted data with deduplication 310 from server 112 in various situations. For example, server 112 may push encrypted data with deduplication 310 sent by the deduplication program 110B on request, such as when the query or an instruction is received. In another embodiment, the deduplication program 110A may send an instruction to server 112 to send the encrypted data with deduplication 310 to the deduplication program 110A. In another embodiment, when deduplication program 110A sent the converted query that is capable of running on the encrypted deduplicated data to the server, such as server 112, the deduplication program 110B may execute the converted query on server 112 and return only an encrypted deduplicated data of interest that includes a deduplication map, encrypted deduplication data, and encrypted plain data.

Next, at 336, deduplication program 110A may decrypt the encrypted data blocks and plain data blocks. According to at least one embodiment, deduplication program 110A may decrypt the received deduplicated encrypted data blocks 312 and encrypted data blocks 316 that were generated by the deduplication program 110A, 110B during data ingestion process and stored on server 112 (FIGS. 2A-2B).

Next, at 338, deduplication program 110A may reconstruct the data based on the deduplication map. According to at least one embodiment, deduplication program 110A, may reconstruct the data in database 304 on a client computing device 102 using the deduplication map 314, deduplicated data blocks 318 and plain data blocks 322 that were received from server 112 and decrypted during step 336. The data may be reconstructed by generating a new data file and copying each block from the plain data blocks 318 and the deduplicated data blocks 318 to the new data file based on the deduplication map 314 that may include the location of each data block from the plain data blocks 318 and the deduplicated data blocks 318.

Next, at 340, deduplication program 110A may search the data using the query. According to at least one embodiment, deduplication program 110A may store the reconstructed data, such as deduplicated data 306, in database 304 on the client computing device 102 and perform a search using one or more queries that may be either entered by the user of client computing device 112 or received by the client computing device 112 using the communication network 114. In another embodiment, if during step 332 deduplication program 110A sent the converted query that is capable of running on the encrypted deduplicated data and the server returned the encrypted data of interest, the deduplication program 110A may decrypt the data without performing a search on the reconstructed data because the search was already performed by the server.

Next, at 342, deduplication program 110A, 110B may display the results. According to at least one embodiment, deduplication program 110A, 110B may display the results from searching the deduplicated data 306 using the query 302 on a display of the client computing device 112, such as display monitor 444.

It may be appreciated that FIGS. 2A-3B provide only an illustration of one implementation and does not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the deduplication program 110A in the client computing device 102, and the deduplication program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the deduplication program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the deduplication program 110A in the client computing device 102 and the deduplication program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the deduplication program 110A in the client computing device 102 and the deduplication program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a, b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

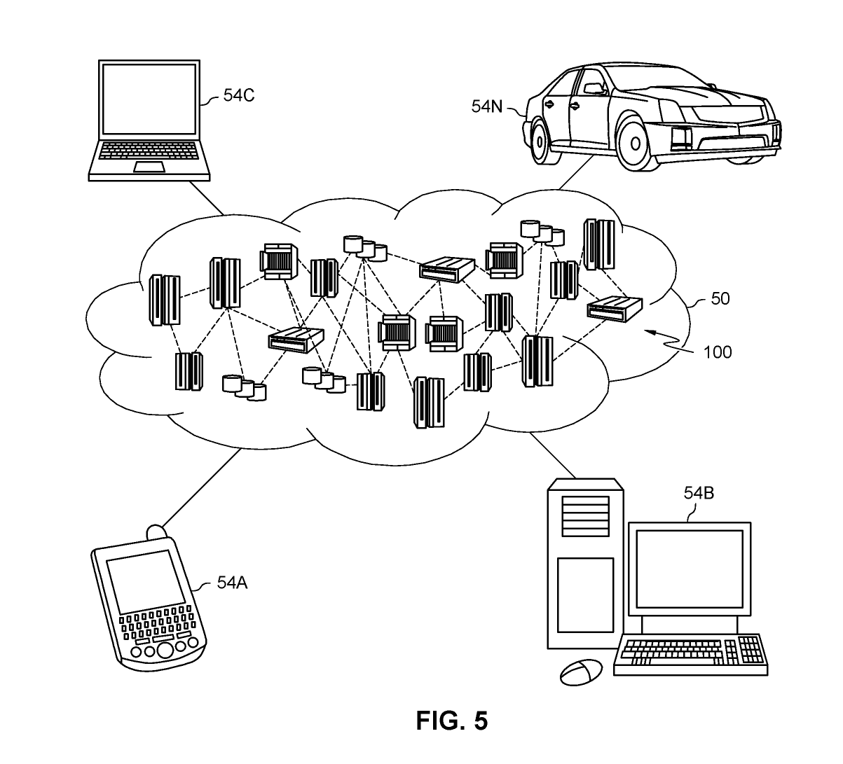

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

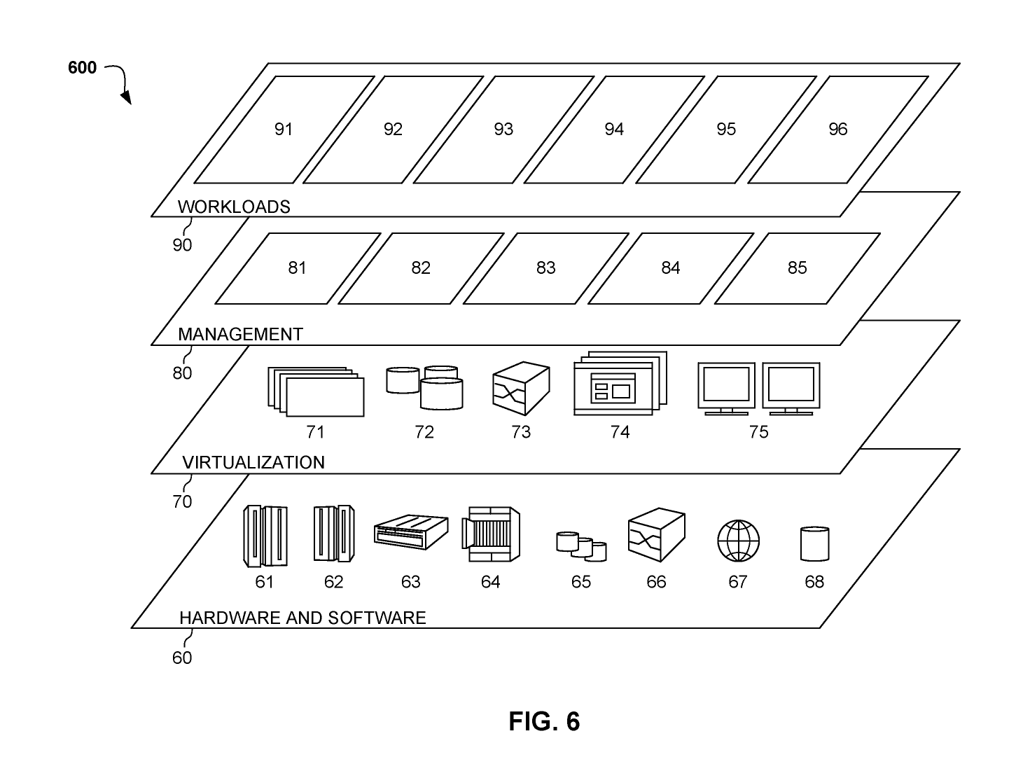

Referring now to FIG. 6, a set of functional abstraction layers 600 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deduplication of cloud-resident encrypted data 96. Deduplication of cloud-resident encrypted data 96 may relate to data deduplication and encryption on a client computing device for storing on a server, while the data includes deduplication map, encrypted plain data blocks and deduplicated encrypted data blocks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for data deduplication on a plurality of cloud-resident encrypted data, the method comprising:
generating one or more deduplication maps based on analyzing a plurality of data and one or more encryption keys;
performing deduplication of the plurality of data based on the one or more deduplication maps, wherein deduplication converts the plurality of data into plain data blocks and deduplicated data blocks;
encrypting the plain data blocks and the deduplication data blocks; and
transferring the one or more deduplication maps, the encrypted plain data blocks, and the encrypted deduplicated data blocks to a server.

2. The method of claim 1, wherein each one of the one or more deduplication maps comprises metadata that stores a location of the deduplicated data blocks and the plain data blocks in the plurality of data.

3. The method of claim 1, wherein encrypting the plain data blocks and the deduplication data blocks further comprises:
based on determining that a block size of an encryption scheme equals to each plain data block and deduplication data block, encrypting the plain data blocks and the deduplication data blocks using the encryption scheme;
based on determining that the block size of the encryption scheme is more than the block size of each plain data block and the deduplication data block, padding each plain data block and the deduplication data block before encrypting the padded plain data blocks and the padded deduplication data blocks using the encryption scheme; and
based on determining that the block size of the encryption scheme is less than the block size of each plain data block and deduplication data block splitting each plain data block and the deduplication data block before encrypting the split plain data blocks and the split deduplication data blocks using the encryption scheme.

4. The method of claim 1, further comprising:
receiving a query;
receiving the deduplication map, the encrypted plain data blocks and the encrypted deduplication data blocks;
decrypting the encrypted plain data blocks and the encrypted deduplication data blocks;
reconstructing the plurality of data from the plain data blocks and the deduplication data blocks based on the deduplication map;
generating results based on searching the plurality of data using the query; and
displaying the results.

5. The method of claim 1, wherein encrypting the plain data blocks and the deduplication data blocks is performed using an encryption scheme, wherein the encryption scheme is selected from a group consisting of at least one of a be a symmetric deterministic encryption scheme, an asymmetric deterministic encryption scheme, a symmetric randomized encryption scheme, and an asymmetric randomized encryption scheme.

6. The method of claim 1, wherein performing deduplication of the plurality of data is based on a deduplication ratio set by a user, wherein the deduplication ratio is a number of bytes input to a data deduplication process divided by a number of bytes output by the data deduplication process.

7. The method of claim 4, wherein, based on receiving the query, receiving the deduplication map, the encrypted plain data blocks and the encrypted deduplication data blocks further comprises:
converting the query to run over the encrypted plain data blocks and the encrypted deduplication data blocks;
transmitting the converted query to the server for determining each encrypted plain data block and each encrypted deduplication data block that is related to the converted query; and
receiving from the server the determined encrypted plain data blocks and the determined encrypted deduplication data blocks.

8. A computer system for data deduplication on a plurality of cloud-resident encrypted data, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
generating one or more deduplication maps based on analyzing a plurality of data and one or more encryption keys;
performing deduplication of the plurality of data based on the one or more deduplication maps, wherein deduplication converts the plurality of data into plain data blocks and deduplicated data blocks;
encrypting the plain data blocks and the deduplication data blocks; and
transferring the one or more deduplication maps, the encrypted plain data blocks, and the encrypted deduplicated data blocks to a server.

9. The computer system of claim 8, wherein each one of the one or more deduplication maps comprises metadata that stores a location of the deduplicated data blocks and the plain data blocks in the plurality of data.

10. The computer system of claim 8, wherein encrypting the plain data blocks and the deduplication data blocks further comprises:
based on determining that a block size of an encryption scheme equals to each plain data block and deduplication data block, encrypting the plain data blocks and the deduplication data blocks using the encryption scheme;
based on determining that the block size of the encryption scheme is more than the block size of each plain data block and the deduplication data block, padding each plain data block and the deduplication data block before encrypting the padded plain data blocks and the padded deduplication data blocks using the encryption scheme; and
based on determining that the block size of the encryption scheme is less than the block size of each plain data block and deduplication data block splitting each plain data block and the deduplication data block before encrypting the split plain data blocks and the split deduplication data blocks using the encryption scheme.

11. The computer system of claim 8, further comprising:
receiving a query;
receiving the deduplication map, the encrypted plain data blocks and the encrypted deduplication data blocks;
decrypting the encrypted plain data blocks and the encrypted deduplication data blocks;
reconstructing the plurality of data from the plain data blocks and the deduplication data blocks based on the deduplication map;
generating results based on searching the plurality of data using the query; and
displaying the results.

12. The computer system of claim 8, wherein encrypting the plain data blocks and the deduplication data blocks is performed using an encryption scheme, wherein the encryption scheme is selected from a group consisting of at least one of a be a symmetric deterministic encryption scheme, an asymmetric deterministic encryption scheme, a symmetric randomized encryption scheme, and an asymmetric randomized encryption scheme.

13. The computer system of claim 8, wherein performing deduplication of the plurality of data is based on a deduplication ratio set by a user, wherein the deduplication ratio is a number of bytes input to a data deduplication process divided by a number of bytes output by the data deduplication process.

14. The computer system of claim 11, wherein, based on receiving the query, receiving the deduplication map, the encrypted plain data blocks and the encrypted deduplication data blocks further comprises:
converting the query to run over the encrypted plain data blocks and the encrypted deduplication data blocks;
transmitting the converted query to the server for determining each encrypted plain data block and each encrypted deduplication data block that is related to the converted query; and
receiving from the server the determined encrypted plain data blocks and the determined encrypted deduplication data blocks.

15. A computer program product for data deduplication on a plurality of cloud-resident encrypted data, the computer program product comprising:
one or more computer-readable tangible storage medium and program instructions stored on at least one of the one or more tangible storage medium, the program instructions executable by a processor, the program instructions comprising:
program instructions to generate one or more deduplication maps based on analyzing a plurality of data and one or more encryption keys;
program instructions to perform deduplication of the plurality of data based on the one or more deduplication maps, wherein deduplication converts the plurality of data into plain data blocks and deduplicated data blocks;
program instructions to encrypt the plain data blocks and the deduplication data blocks; and
program instructions to transfer the one or more deduplication maps, the encrypted plain data blocks, and the encrypted deduplicated data blocks to a server.

16. The computer program product of claim 15, wherein each one of the one or more deduplication maps comprises metadata that stores a location of the deduplicated data blocks and the plain data blocks in the plurality of data.

17. The computer program product of claim 15, wherein program instructions to encrypt the plain data blocks and the deduplication data blocks further comprises:
based on determining that a block size of an encryption scheme equals to each plain data block and deduplication data block, program instructions to encrypt the plain data blocks and the deduplication data blocks using the encryption scheme;
based on determining that the block size of the encryption scheme is more than the block size of each plain data block and the deduplication data block, program instructions to pad each plain data block and the deduplication data block before program instructions to encrypt the padded plain data blocks and the padded deduplication data blocks using the encryption scheme; and
based on determining that the block size of the encryption scheme is less than the block size of each plain data block and deduplication data block, program instructions to split each plain data block and the deduplication data block before program instructions to encrypt the split plain data blocks and the split deduplication data blocks using the encryption scheme.

18. The computer program product of claim 15, further comprising:
program instructions to receive a query;
program instructions to receive the deduplication map, the encrypted plain data blocks and the encrypted deduplication data blocks;
program instructions to decrypt the encrypted plain data blocks and the encrypted deduplication data blocks;
program instructions to reconstruct the plurality of data from the plain data blocks and the deduplication data blocks based on the deduplication map;
program instructions to generate results based on searching the plurality of data using the query; and
program instructions to display the results.

19. The computer program product of claim 15, wherein program instructions to encrypt the plain data blocks and the deduplication data blocks is performed using an encryption scheme, wherein the encryption scheme is selected from a group consisting of at least one of a symmetric deterministic encryption scheme, an asymmetric deterministic encryption scheme, a symmetric randomized encryption scheme, and an asymmetric randomized encryption scheme.

20. The computer program product of claim 15, wherein program instructions to perform deduplication of the plurality of data is based on a deduplication ratio set by a user, wherein the deduplication ratio is a number of bytes input to a data deduplication process divided by a number of bytes output by the data deduplication process.
